(19) United States
(12) Patent Application Publication
(10) Pub. No.: US 2010/0283898 A1
(43) Pub. Date: Nov. 11, 2010

(54) AUTOMATIC SETTINGS SELECTION BASED ON MENU LANGUAGE SELECTION

(75) Inventor: Mark Gilmore Mears, Zionsville, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD., Shekou, Shenzhen, Guangdong (CN)

(21) Appl. No.: 12/742,420

(22) PCT Filed: Feb. 25, 2008
(86) PCT No.: PCT/US08/54883

§ 371 Date: May 11, 2010

(30) Foreign Application Priority Data
Dec. 4, 2007 (CN) 200710124805.7

(51) Int. Cl. H04N 7/00; H04N 5/50

(52) U.S. Cl. 348/468; 348/731; 348/E07.001; 348/E05.097

(57) ABSTRACT

An exemplary electronic device comprises a language selection control logic and is adapted to receive a menu language selection setting from a user. The language selection control logic is adapted to set, based on the received menu language selection setting from the user, an alternate audio programming setting corresponding to the menu language setting, and at least one caption setting corresponding to the menu language setting, so that the menu language setting is applied to the playing of the audio data on an audio subsystem and video data on a display subsystem of the electronic device.

### FIELD OF THE INVENTION

The present invention relates generally to video devices. More specifically, the present invention relates to video devices that support multiple language features.

### BACKGROUND

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

In response to the growing population of non-English speakers, many television sets (TVs) are now supporting multiple language features that may be accessed and enabled through a user interface, for example, an onscreen selection menu. The selection menu may permit a non-English speaking user to change the menu language (usually set to English by default) so that the menu options will appear onscreen in the user's native language. In addition, the menu options may also allow for a non-English speaking user to enable appropriate alternate audio programming (for example, secondary audio programming (SAP) or the like in the NTSC format, or alternate audio tracks, audio languages, audio modes or the like in the ATSC format) settings, as well as closed captioning settings corresponding to the desired language selected by the user.

Often times, enabling such additional language features may require the user to perform a number of additional menu selection steps. Thus, a non-English speaking user may be required to perform a complex series of menu selection steps in order to properly configure a TV to more fully operate in the user's native language. This is not only inconvenient, but may also be confusing to non-English speaking users who may not be aware of all the necessary menu selection steps they need to perform in order to more fully enjoy their TV. Therefore, an improved system and method of adjusting TV language settings is desirable.

### BRIEF DESCRIPTION OF THE DRAWINGS

In the drawings:

FIG. 1 is a block diagram of an electronic device that may employ an exemplary embodiment of the present invention; and

FIG. 2 is a process flow diagram illustrating a method in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An exemplary embodiment of the present invention relates to an electronic device that supports, in response to a selected menu language setting input, automatic adjustment of other language settings for the electronic device in order to properly configure the electronic device to operate in a desired language corresponding to the menu language setting input. In an exemplary embodiment of the present invention, the menu language setting input may be selected by a user through a user interface, for example, a graphical user interface provided in a TV. Moreover, the automatic adjustment of language settings based on the menu language setting input may include setting alternate audio programming channels (SAP, alternate audio tracks, etc.), as well as setting at least one caption setting to correspond to the desired language. Caption features display the audio portion of a video program as text superimposed over the video data. In addition, after selecting the menu language setting, the user interface of the electronic device may provide the user with a prompt notifying the user of the language settings to be adjusted based on the menu language setting input, allowing the user to approve or reject one or more of the language setting changes before the language settings are applied to the electronic device.

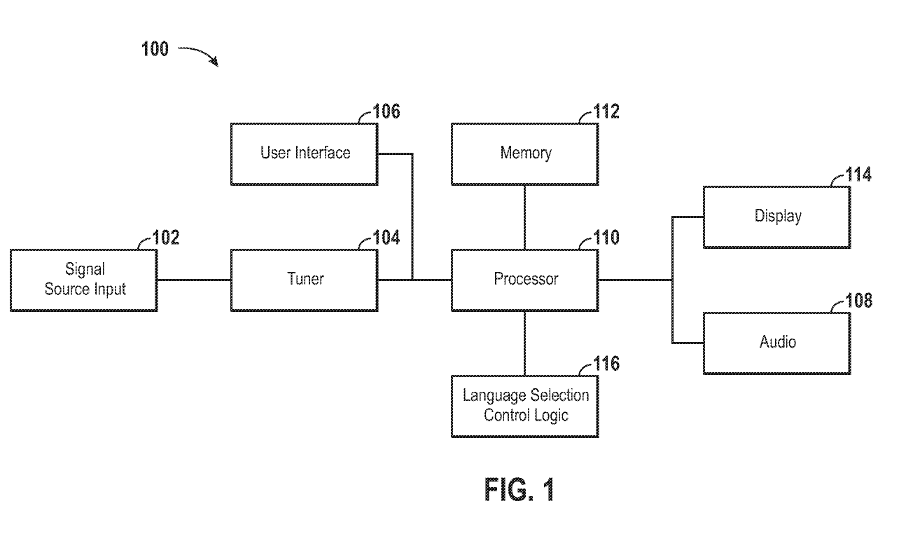

FIG. 1 is a block diagram of an electronic device that may employ an exemplary embodiment of the present invention. The electronic device is generally referred to by the reference numeral 100. The electronic device 100 (for example, a television, a portable DVD player, a set top box or the like) comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

Specifically, in the illustrated embodiment, the electronic device 100 includes a signal source input 102, a tuner 104, a user interface 106, an audio subsystem 108, processor 110, a memory 112, a display 114, and a language selection control logic feature 116. A signal source input 102 may comprise an antenna input, an RCA input, an S-video input, a composite video input or the like. Those of ordinary skill in the art will appreciate that, although only one signal source is shown, the electronic 100 may have multiple signal source inputs. The signal source input 102 is adapted to receive a signal that comprises video data and, in some cases, audio data and captioning data. The signal received by the signal source input 102 may comprise a broadcast spectrum (e.g., if the signal source input 102 comprises an antenna) or a single channel of video and/or audio data (e.g., if the signal source input 102 comprises a DVD player or the like).

In the illustrated embodiment, the tuner 104 is communicatively coupled with the signal source input 102. The tuner 104 is adapted to tune a particular video program from a broadcast signal received from the signal source input 102. In some embodiments the tuner 104 may be bypassed if the signal source input 102 receives a stored video signal. Indeed, those of ordinary skill in the art will appreciate that input signals that are not received as part of a broadcast spectrum may bypass the tuner 104 because tuning is not required to isolate a video program associated with those signals.

In the illustrated embodiment, a user interface 106 may include a graphical user interface having a plurality of menus, viewable through the display subsystem 114. The user interface 106 allows a user to adjust various configuration options for the electronic device 100. For example, one such configuration option may include selecting or changing the menu language setting. To set a menu language, the user may access and navigate through the user interface 106 via controls coupled to the electronic device 100 (e.g., selection buttons, dials, knobs or the like) and/or via a remote control device. As discussed below, the menu language selection input will be used to determine additional language settings to be applied to the electronic device 100.

The electronic device 100 may include an audio subsystem 108. The audio subsystem 108, which may comprise an audio amplifier and one or more speakers, may be adapted to play audio data associated with video data being displayed by the electronic device 100.

The processor 110 is adapted to control the overall operation of the electronic device 100. Such control may be achieved by the processor 110 when the processor 110 cooperates with the memory 112 to perform operations in accordance with embodiments of the present invention. Specifically, for example, the memory 112 may be associated with the processor 110 such that the memory 112 stores machine-readable computer code that causes the processor 110 to control the operation of the electronic device 100 in a manner in accordance with present embodiments.

The display 114 of the electronic device 100 is configured to display video data received via the signal source input 102. Specifically, the display 114 may display video data in accordance with one or more language settings applied by the language selection control logic 116, in accordance with present embodiments. The display subsystem 114 may comprise a liquid crystal (LCD) display, a liquid-crystal-on-silicon (LCOS) display, a digital light projection (DLP) display or any other suitable display type. The display subsystem 114 may include a lighting source (not shown) that is used to generate a visible image on the display.

In an exemplary embodiment of the present invention, the language selection control logic 116 is adapted to set language settings for the electronic device 100 based on a menu language selection input. As described above, a menu language setting may be selected by the user through the user interface 106. In an exemplary embodiment of the present invention, the language selection control logic 116 is adapted to set an alternate audio programming setting and one or more caption settings to correspond to the menu language selection input. The alternate audio settings set by the language selection control logic 116 are applied respectively to the playing of audio data via the audio subsystem 108 when alternate audio programming is turned on by the user. Similarly, the new language set for the caption setting is used to display captions when captioning is enabled by the user. By way of example, when a user sets the menu language setting to Spanish, the language selection control logic 116 may be adapted to set alternate audio (SAP, alternate audio tracks or the like) and caption settings for the electronic device 100 to correspond to Spanish and to apply the settings to the electronic device 100, wherein playing of audio data via the audio subsystem 108 includes outputting a Spanish audio channel when alternate audio programming is enabled by the user, and playing of video data on the display 114 includes displaying Spanish captions superimposed over the video data when captioning is enabled by the user.

In an exemplary embodiment of the present invention, the language selection control logic 116 may be adapted to set both analog and digital caption settings and analog and digital alternate audio programming settings based on the menu language selection input. Examples of caption settings that may be set by the language selection control logic include closed captioning analog caption settings (CC2), which may be associated with analog video data (e.g., analog cable or antenna video signals), as well as digital caption settings (Service2) which may be associated with digital video data (e.g., Digital TV, High Definition TV). In an exemplary embodiment of the present invention, the electronic device 100 is adapted to display analog captions corresponding to the menu language selection input during the playing of analog video data, and to display digital captions corresponding to the menu language selection input during the playing of digital video data.

One or more situations may exist in which a user prefers only some, but not all of the language settings set by the language selection control logic 116 to be applied to the playing of video and/or audio data on the electronic device 100. For example, a user attempting to learn the English language may prefer to view captions in the user's native language, but to listen to the audio programming in English. Accordingly, the language selection control logic 116 may be further adapted to notify the user of the language settings to be applied in response to the menu language selection input, and to wait for a response from the user prior to applying the language settings to the electronic device 100. In an exemplary embodiment of the present invention, the language selection control logic 116 may by adapted to provide one or more prompts, which may appear on the display 114, informing the user of the language settings to be applied to the electronic device 100 based on the menu language selection input. The prompts may be adapted to provide the user with the option to accept or reject one or more of the language settings through the user interface 106, which may include responding with one or more acceptance or rejection signals by manipulating controls coupled to the electronic device 100 (e.g., selection buttons, dials, knobs or the like) or via a remote control device, wherein the language selection control logic 116 is adapted to apply only the accepted language settings to the electronic device 100.

In one or more embodiments of the present invention, the language selection control logic 116 may generate a separate prompt for each language setting to be set by the language selection control logic 116. For example, the language selection control logic 116 may display a first prompt that prompts the user to accept or reject an alternate audio programming setting, followed by a second prompt that prompts the user to accept or reject a caption setting. In alternative embodiments of the present invention, the language selection control logic 116 may generate a single prompt listing all the language settings to be set by the language selection control logic 116, wherein the user may accept or reject one or more of the language settings in the listing. The language selection control logic 116 may be further adapted to apply only accepted language settings to the playing of video and/or audio data on the electronic device 100. In this manner, the user may operate the electronic device 100 to display audio and video data in the language preferred by the user, so that the user may more fully enjoy use of the electronic device 100.

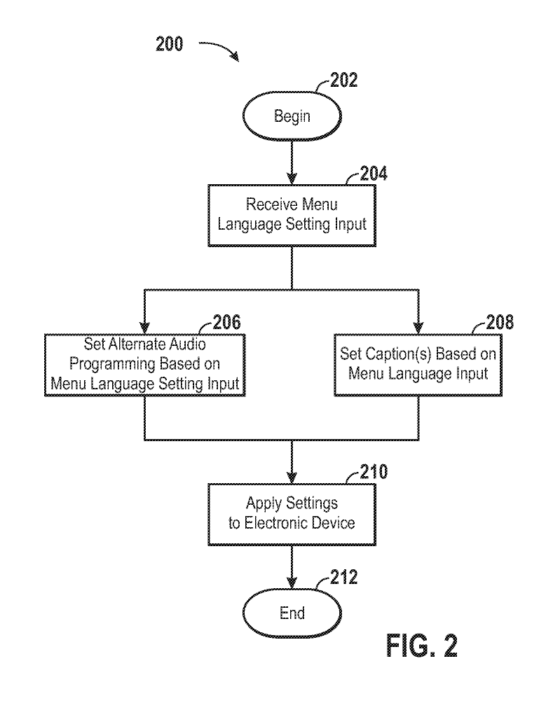

FIG. 2 is a process flow diagram illustrating a method in accordance with an exemplary embodiment of the present invention. The process is generally referred to by the reference number 200. At block 202, the process begins.

At block 204, a desired menu language setting input is received by the language selection control logic 116 (FIG. 1). As discussed above, the menu language setting may be set by a user through a user interface 106 (FIG. 1) of the electronic device 100 (FIG. 1). In response to the menu language setting, the language selection control logic 116 (FIG. 1) may be adapted to set an alternate audio programming setting to correspond to the menu language setting input, as illustrated at block 206, and to set one or more caption settings to correspond to the menu language setting input, as illustrated at block 208.

As discussed above, in an exemplary embodiment of the present invention, the language selection control logic 116 (FIG. 1) may be adapted to prompt the user to accept or reject one or more of the alternate audio programming and caption settings corresponding to the menu language setting input received at block 204. Subsequently, only the accepted language settings are set by the language selection control logic 116 (FIG. 1). At block 210, accepted language settings set by the language selection control logic 116 (FIG. 1) are applied to the playing of video and/or audio data on the electronic device 100 (FIG. 1). Playing of video and/or audio data in accordance with the language settings may include displaying captions corresponding to the menu language selection input on the display 114 (FIG. 1) and/or playing an alternative audio program corresponding to the menu language selection input via the audio subsystem 108 (FIG. 1). Thereafter, the process ends at block 212.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An electronic device, comprising:
a tuner that is adapted to tune a desired program;
a display;
a processor that is adapted to receive a signal from the tuner, to convert the signal to audio and/or video data corresponding to the desired program and to play the audio and/or video data on the display; and
a language selection control logic that is adapted to set a alternate audio programming setting and at least one caption setting to a value entered for a menu language setting, so that the value entered for the menu language setting is applied to the playing of the audio and/or video data on the display.

2. The electronic device of claim 1, further comprising a user interface adapted to permit a user to select the menu language setting.

3. The electronic device of claim 1, wherein the at least one caption setting includes a closed captioning (CC) analog caption setting.

4. The electronic device of claim 3, wherein the language selection control logic is adapted to prompt a user before setting the closed captioning (CC) analog caption setting to the value entered for a menu language setting.

5. The electronic device of claim 4, wherein the language selection control logic is adapted to set the closed captioning (CC) analog caption setting to the value entered for a menu language setting only if the user accepts the closed captioning (CC) analog caption setting in response to the prompt.

6. The electronic device of claim 1, wherein the at least one caption setting includes a digital caption setting.

7. The electronic device of claim 6, wherein the language selection control logic is adapted to prompt a user before setting the digital caption setting to the value entered for a menu language setting.

8. The electronic device of claim 7, wherein the language selection control logic is adapted to set the digital caption setting to the value entered for a menu language setting only if the user accepts the digital caption setting in response to the prompt.

9. The electronic device of claim 1, wherein the language selection control logic is adapted to prompt a user before setting the alternate audio programming setting to the value entered for a menu language setting.

10. The electronic device of claim 9, wherein the language selection control logic is adapted to set the alternate audio programming setting to the value entered for a menu language setting only if the user accepts the alternate audio programming setting in response to the prompt.

11. A method of operating an electronic device, the method comprising:
receiving a menu language setting input from a user; and
responsive to the menu language setting input, setting an alternate audio programming setting and at least one caption setting to correspond to the menu language setting input; and
applying the alternate audio programming setting and the at least one caption setting to the playing of video and/or audio data on the electronic device.

12. The method of claim 11, wherein setting the at least one caption setting to correspond to the menu language setting input includes setting a closed caption (CC) analog caption setting.

13. The method of claim 12, wherein setting the closed caption (CC) analog caption setting includes first returning a prompt to a user, wherein the prompt is adapted to permit the user to accept or reject the closed caption (CC) analog caption setting to correspond to the menu language setting input.

14. The method of claim 13, wherein setting the closed caption (CC) analog caption setting to correspond to the menu language setting input depends on the user accepting the closed caption (CC) analog caption setting in response to the prompt.

15. The method of claim 11, wherein setting the at least one caption setting to correspond to the menu language setting input includes setting a digital caption setting.

16. The method of claim 15, wherein setting the digital caption setting includes first returning a prompt to a user, wherein the prompt is adapted to permit the user to accept or reject the digital caption setting to correspond to the menu language setting input.

17. The method of claim 16, wherein setting the digital caption setting to correspond to the menu language setting input depends on the user accepting the digital caption setting in response to the prompt.

18. The method of claim 11, wherein setting the alternate audio programming setting includes first returning a prompt to a user, wherein the prompt is adapted to permit the user to accept or reject setting the alternate audio programming setting to correspond to the menu language setting input.

19. The method of claim 18, wherein setting the alternate audio programming setting to correspond to the menu language setting input depends on the user accepting the alternate audio programming setting in response to the prompt.

20. An electronic device, comprising:
means for tuning a desired program;
means for displaying the desired program;
means for receiving a signal from the tuner, converting the signal to audio and/or video data corresponding to the desired program and playing the audio and/or video data; and
means for setting an alternate audio programming setting and at least one caption setting to a value entered for a menu language setting, so that the value entered for the menu language setting is applied to the playing of the audio and/or video data.
